(19) United States
(12) Patent Application Publication
(10) Pub. No.: US 2023/0374270 A1
(43) Pub. Date: Nov. 23, 2023

(54) ELECTRICALLY CONDUCTIVE POLYMER COMPOSITES WITH BIOCHAR FIBERS

(71) Applicant: Ford Global Technologies, LLC, Dearborn, MI (US)

(72) Inventors: Alper Kiziltas, Sarikamis (TR); Chinmoyee Das, Houghton, MI (US); Sandeep Tamrakar, Ann Arbor, MI (US); Deborah Frances Mielewski, Ann Arbor, MI (US); Xinfeng Xie, Houghton, MI (US)

(73) Assignee: Ford Global Technologies, LLC, Dearborn, MI (US)

(21) Appl. No.: 17/749,965

(22) Filed: May 20, 2022

(51) Int. Cl. C08K 7/04; C08K 3/04; C08J 5/04

(52) U.S. Cl. CPC C08K 7/04; C08K 3/04; C08J 5/042; C08K 2201/001; C08K 2201/003; C08J 2333/24

(57) ABSTRACT

A composite material composition includes a polymer matrix and biochar fibers disposed throughout the polymer matrix. The polymer matrix of the composite material composition may be a recycled material and the biochar fibers may made from a natural material.

### FIELD

The present disclosure relates to composite materials, and more particularly to composites with electrically conductive filler materials.

### BACKGROUND

The statements in this section merely provide background information related to the present disclosure and may not constitute prior art.

Motor vehicles are increasingly subjected to various emissions and fuel consumption standards. These standards are typically promulgated to lower carbon dioxide emissions, thereby reducing greenhouse gas in the atmosphere. One way to meet these standards is to reduce the weight of motor vehicles. One weight-reduction strategy is the use of composite materials in various vehicle components, which have a much lower material density than their metal counterparts. However, various fillers and reinforcements used in composite materials can be quite dense and are relatively expensive. For example, carbon based fillers such as carbon nanotubes, carbon fibers, and carbon black have been used as structural fillers as well as to provide a certain level of electrical conductivity to a composite vehicle component for electrostatic dissipation. While providing weight savings as well as the desired structural performance and mechanical/electrical properties, the manufacture of carbon based fillers is energy and time intensive, thereby contributing to the higher costs of composite materials.

The present disclosure addresses these challenges related to the cost effective and sustainable implementation of lightweight composite materials in motor vehicles.

### SUMMARY

This section provides a general summary of the disclosure and is not a comprehensive disclosure of its full scope or all of its features.

In one form of the present disclosure, a composite material composition includes a polymer matrix and biochar fibers disposed throughout the polymer matrix.

In variations of the composite material composition, which may be implemented individually or in any combination: the biochar fibers have a length-to-diameter (L/D) aspect ratio of at least 30; an average diameter of the biochar fibers is between about 6.5 μm and about 7.5 μm; the average diameter of the biochar fibers is about 7 μm; the polymer matrix is a polyamide material; the polymer matrix is a recycled material; the recycled material is nylon; the biochar fibers are in an amount between about 7.5 wt. % and about 35.0 wt. %, and the composite material has a corresponding a volume resistivity between about 7,130 ohm-cm and about 2.1 ohm-cm; the biochar fibers are formed from a natural material; and the natural material is Douglas fir pulp.

In another form of the present disclosure, a composite material composition includes a polymer matrix and biochar fibers disposed throughout the polymer matrix, wherein the biochar fibers have a length-to-diameter (L/D) aspect ratio of at least 30.

In variations of this composite material composition, which may be implemented individually or in any combination: the polymer matrix is a polyamide material; the polymer matrix is a recycled material; the recycled material is nylon; the biochar fibers are in an amount between about 7.5 wt. % and about 35.0 wt. %, and the composite material has a corresponding a volume resistivity between about 7,130 ohm-cm and about 2.1 ohm-cm; and the biochar fibers are formed from a natural material; the natural material is Douglas fir pulp.

In yet another form, a composite material composition includes a polymer matrix consisting of a recycled material and biochar fibers disposed throughout the polymer matrix, the biochar fibers consisting of a natural material, wherein the biochar fibers have a length-to-diameter (L/D) aspect ratio of at least 30.

In variations of this composite material composition, which may be implemented individually or in any combination, an average diameter of the biochar fibers is between about 6.5 μm and about 7.5 μm; the biochar fibers are in an amount between about 7.5 wt. % and about 35.0 wt. %, and the composite material has a corresponding a volume resistivity between about 7,130 ohm-cm and about 2.1 ohm-cm.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a schematic view of a composite material according to the teachings of the present disclosure.

FIG. 2 is a flow diagram illustrating a method of manufacturing the composite material of FIG. 1;

FIG. 3 is a schematic view of an apparatus for generating biochar fibers from biomass according to the present disclosure; and

FIG. 4 is a schematic view of an apparatus for molding a composite material with the biochar fibers according to the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

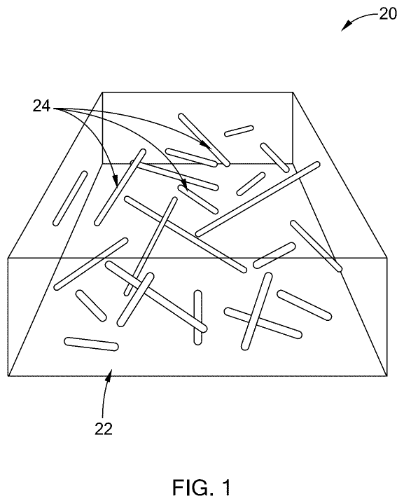

Referring to FIG. 1, a composite material composition according to the teachings of the present disclosure is illustrated and generally indicated by reference numeral 20. The composite material 20 includes a polymer matrix 22 and biochar fibers 24 disposed throughout the polymer matrix 22.

As used herein, “biochar fibers” should be construed to mean fibers of biochar, which is the solid material obtained from the thermochemical conversion of an organic substance (e.g., biomass) in an oxygen-limited environment. The organic material is converted, partially or completely, into chains of carbon molecules that can provide electrical conductivity, and more particularly herein, to a composite material. The thermochemical conversion is one of a pyrolysis process or a carbonization process. A “pyrolysis” process is a process by which the organic substance is at least partially thermochemically converted into solid carbon in an oxygen-limited environment. A “carbonization” process is a process that thermochemically converts most or all of the organic substance into carbon in an oxygen-limited environment. In one form, the organic material is a natural material such as Douglas fir pulp or hemp. It should be understood, however, that any number of natural materials, and combinations thereof, may be implemented while remaining within the scope of the present disclosure.

The biochar fibers 24 are dispersed throughout the polymer matrix 22 as shown, and in an amount dictated by performance requirements (e.g., electrical and mechanical properties). While the biochar fibers 24 are shown as discontinuous, it should be understood that the biochar fibers 24 may be continuous while remaining within the scope of the present disclosure. The polymer matrix 22 may be any of a variety of polymers suitable for the composite material 20, and more specifically for the desired material properties for a given application. In one form, the polymer matrix 22 is a recycled material, such as excess polyamide material recovered from additive manufacturing processes such as selective laser sintering (SLS). In another form, the polymer matrix 22 is recycled nylon. Further, the polymer matrix 22 may be either a thermoplastic or a thermoset polymer material.

In one form, the biochar fibers 24 have a length-to-diameter (L/D) aspect ratio of at least 30. In one form, an average diameter of the biochar fibers 24 is between about 6.5 micrometers (μm) and about 7.5 μm, and the biochar fibers 24 are cut to specified lengths to achieve the specified aspect ratio. The diameter of the biochar fibers 24 is determined by the biomass from which the biochar fibers are carbonized, and different biomass feeds (described in greater detail below) are used to form the biochar fibers 24 with specified diameters. As such, the biochar fibers 24 are cut to specified lengths according to the diameters of the biomass feed to maintain the L/D aspect ratio.

As set forth above, the amount (e.g., wt. %) of biochar fibers 24 is determined based on both specified resistivity and mechanical properties of the composite material 20. The “resistivity” as used herein is an amount of electrical resistance for a unit length, typically measured in ohm-centimeters (ohm-cm, Ω-cm). In one form, the biochar fibers 24 are in an amount between about 7.5 wt. % and about 35.0 wt. % of the overall composite material 20 weight, and the composite material 20 has a corresponding a volume resistivity between about 7130 ohm-cm and about 2.1 ohm-cm. Table 1 below shows the weight of the biochar fibers 24, the weight of the polymer matrix 22, and the resistivity of different composite materials 20 at different weight percents of the biochar fibers 24 according to various forms of the present disclosure.

TABLE 1
Composite Material Compositions of the Present Disclosure

| Biochar Fibers | Polymer | Resistivity |
|---|---|---|
| (wt. %) | (wt. %) | (Ω-cm) |
| 7.5 | 92.5 | 7130 ± 6336 |
| 9 | 91 | 4005 ± 4995 |
| 15 | 85 | 210.8 ± 156.1 |
| 25 | 75 | 11.0 ± 1.71 |
| 35 | 65 | 2.13 ± 0.45 |

As shown above, as the loading rate of biochar fibers 24 increases, the resistivity of the composite material 20 decreases. The decreased resistivity improves the conductivity of the composite material 20, and thus the specific conductive requirements of the vehicle component are achieved by including a specific wt. % of biochar fibers 24. For example, a vehicle component that has a relatively low conductivity requirement could be formed from the 7.5 wt. % composite material 20, and a vehicle component with a relatively high conductivity requirement could be formed from the 35 wt. % composite material. It should be understood that the compositional ranges as illustrated herein for the composite material 20 are merely exemplary and should not be construed as limiting the scope of the present disclosure.

Additional testing was conducted to compare the biochar fibers 24 to conventional carbon fibers, both with a PA-12/nylon polymer matrix, the results of which are shown below in Table 2:

TABLE 2

| Filler | Biochar Fiber Resistivity | Carbon Fiber Resistivity |
|---|---|---|
| (wt. %) | (Ω-cm) | (Ω-cm) |
| 7.5 | 7130 ± 6336 | — |
| 9 | 4005 ± 4995 | 8.39 × 10⁴ ± 1.02 × 10⁵ |
| 15 | 210.8 ± 156.1 | 482.98 ± 176.15 |
| 25 | 11.0 ± 1.71 | 97.47 ± 16.7 |
| 35 | 2.13 ± 0.45 | 94.81 ± 8.1 |

Biochar vs Carbon Fiber Comparisons

As shown, with higher percentages of biochar filler, the resistivity decreases. With even higher percentages of biochar filler than those shown, it is contemplated that the teachings of the present disclosure can also provide for static dissipation in a part formed from the inventive composite material. This capability to have a part with static dissipation should be construed as being within the scope of the present disclosure.

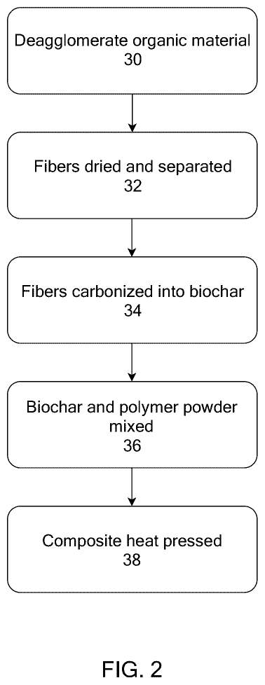

With reference to FIG. 2, a flow diagram illustrating a process for manufacturing the composite material 20 is shown. The process begins in a block 30, in which fibers of the organic material are deagglomerated (i.e., separated and/or disentangled from each other). In one form, the organic fibers are deagglomerated by soaking the fibers in heated water and agitating the fiber-water mixture to separate the fibers from each other. The water is filtered, and the wet fibers are washed in a drying substance (such as ethanol) to dry out any remaining water, preventing further agglomeration of the fibers to each other.

Next, in a block 32, the fibers are dried and separated in a mixing device. In one form, the deagglomerated fibers are dried in an oven at 80° C. and then introduced to the mixing device, such as by way of example, a coffee grinder. The coffee grinder includes a rotating set of blades that further separate the fibers from each other. In one form, the blades of the coffee grinder are blunted, such as with a covering, to separate the fibers without cutting the fibers.

Next, in block 34, the fibers are carbonized into biochar fibers 24. As described below, the fibers are introduced to a heat source/heater that carbonizes the fibers in a low-oxygen environment to remove volatile chemical species from the fibers. In one form, the fibers are carbonized in a three-zone heating carbonization furnace in a nitrogen environment by increasing heat in the furnace at specified intervals, each interval increasing the temperature by 10° C., until an air temperature of the furnace reaches 1000° C. The fibers are held at this temperature for a specified period of time until the biochar fibers 24 form.

Next, in a block 36, the biochar fibers 24 and a polymer powder are mixed. In one form, the biochar fibers 24 and the polymer powder are dried in the oven at 80° C. again and then dispersed in the mixing device (such as the coffee grinder described above). The mixing device disperses the particles of the polymer powder and the biochar fibers 24 such that the biochar fibers 24 are distributed throughout the polymer powder.

Next, in a block 38, the biochar fibers 24 and the polymer powder are formed into the composite material 20. In one form, the composite material 20 is formed under heat and pressure in a molding process. As described below, a heat press applies heat and pressure to the fiber-polymer mixture, melting and subsequently curing the polymer powder into the polymer matrix 22 and securing the biochar fibers 24 within the polymer matrix 22. In one form, the fiber-polymer mixture is placed into a die, a pressure of 96 pounds per square inch (PSI) is applied, and a temperature of the heat press is increased to 300° C. Then, the fiber-polymer mixture is held at this temperature and pressure for about 30 minutes. Then, the die is cooled from about 300° C. to 35° C., solidifying the polymer matrix 22. At this point, the composite material 20 is formed.

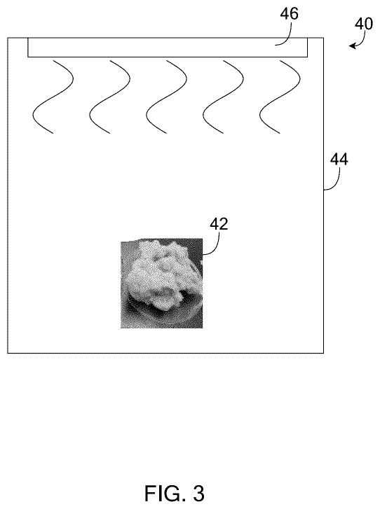

Now referring to FIG. 3, a heating apparatus 40 is used to generate the biochar fibers 24 from an organic material 42. The heating apparatus 40 includes a housing 44 and a heat source 46 supported within the housing 44. The housing 44 in one form includes a thermally insulating material (not shown), to reduce heat transfer from the heat source 46 within the housing 44 to an outside environment, thereby providing more heat transfer to the organic material 42. The heat source 46 is any suitable type, such as by way of example, a resistance heater, a combustion heater, a visible light heater, an induction heater, or an electromagnetic heater, among others.

The heat source 46 emits heat into the housing 44, which heats the organic material 42 in a low-oxygen or oxygen-free environment, such as a nitrogen environment. The low-oxygen environment inhibits hydrocarbons from undergoing stoichiometric combustion reactions, and when the organic material 42 is heated, oxygen, hydrogen, and other volatile chemical species evaporate from the organic material 42. The remaining unevaporated material is predominantly carbon, specifically, fibers of biochar 24. In one form, the heating apparatus 40 heats Douglas fir pulp at increasing increments of 10 degrees Celsius in an inert nitrogen environment until the organic material reaches about 1000° C. The resulting biochar in this form is about 88% carbon.

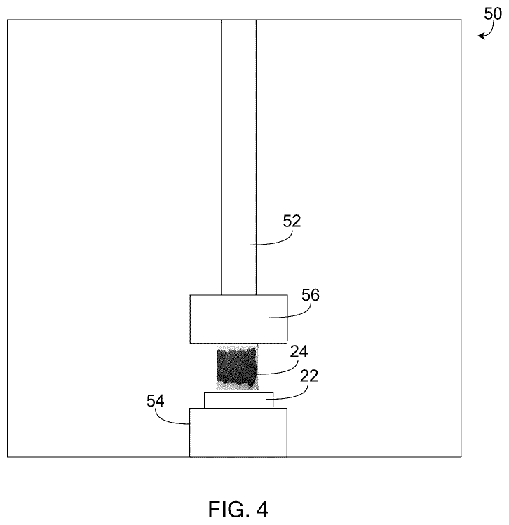

With reference to FIG. 4, a compression mold 50 is used to compress the composite material 20 into a final product form. It should be understood that processes other than compression molding may be employed while remaining within the scope of the present disclosure. The compression mold 50 includes a heated press 52 and a die 54. The die 54 holds and shapes the polymer matrix 22 and the biochar fibers 24, and the heated press 52 provides pressure to distribute the biochar fibers 24 throughout the polymer matrix 22. The heated press 52 includes a heating element 56 to heat the biochar fibers 24 and the polymer matrix 22 in contact with the heated press 52. Heating the biochar fibers 24 and the polymer matrix 22 allows the pressure from the heated press 52 to more readily distribute the biochar fibers 24 through the polymer matrix 22.

Using biomass feed and recycled polymer, the composite material 20 is sustainably produced from waste materials. Carbonizing the biomass into biochar fibers 24 can provide electrical conductivity to the composite material 20, which can be used in a variety of vehicle components, such as exterior panels to inhibit electrostatic deposition. The composite material 20 is thus lighter than conventional materials while providing electrical conductivity for vehicles components and is sustainably produced from recycled materials.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. For example, it is contemplated that the biochar fibers as described herein could be recyclable and used for further applications while remaining within the scope of the present disclosure. Such variations are not to be regarded as a departure from the spirit and scope of the disclosure.

What is claimed is:

1. A composite material composition comprising:
a polymer matrix; and
biochar fibers disposed throughout the polymer matrix.

2. The composite material according to claim 1, wherein the biochar fibers have a length-to-diameter (L/D) aspect ratio of at least 30.

3. The composite material according to claim 2, wherein an average diameter of the biochar fibers is between about 6.5 μm and about 7.5 μm.

4. The composite material according to claim 3, wherein the average diameter of the biochar fibers is about 7 μm.

5. The composite material according to claim 1, wherein the polymer matrix is a polyamide material.

6. The composite material according to claim 1, wherein the polymer matrix is a recycled material.

7. The composite material according to claim 6, wherein the recycled material is nylon.

8. The composite material according to claim 1, wherein the biochar fibers are in an amount between about 7.5 wt. % and about 35.0 wt. %, and the composite material has a corresponding a volume resistivity between about 7,130 ohm-cm and about 2.1 ohm-cm.

9. The composite material according to claim 1, wherein the biochar fibers are formed from a natural material.

10. The composite material according to claim 9, wherein the natural material is Douglas fir pulp.

11. A composite material composition comprising:
a polymer matrix; and
biochar fibers disposed throughout the polymer matrix, wherein the biochar fibers have a length-to-diameter (L/D) aspect ratio of at least 30.

12. The composite material according to claim 1, wherein the polymer matrix is a polyamide material.

13. The composite material according to claim 11, wherein the polymer matrix is a recycled material.

14. The composite material according to claim 13, wherein the recycled material is nylon.

15. The composite material according to claim 11, wherein the biochar fibers are in an amount between about 7.5 wt. % and about 35.0 wt. %, and the composite material has a corresponding a volume resistivity between about 7,130 ohm-cm and about 2.1 ohm-cm.

16. The composite material according to claim 11, wherein the biochar fibers are formed from a natural material.

17. The composite material according to claim 16, wherein the natural material is Douglas fir pulp.

18. A composite material composition comprising:
a polymer matrix consisting of a recycled material; and
biochar fibers disposed throughout the polymer matrix, the biochar fibers consisting of a natural material, wherein the biochar fibers have a length-to-diameter (L/D) aspect ratio of at least 30.

19. The composite material according to claim 18, wherein an average diameter of the biochar fibers is between about 6.5 μm and about 7.5 μm.

20. The composite material according to claim 18, wherein the biochar fibers are in an amount between about 7.5 wt. % and about 35.0 wt. %, and the composite material has a corresponding a volume resistivity between about 7,130 ohm-cm and about 2.1 ohm-cm.
